(19) United States
(12) Patent Application Publication
(10) Pub. No.: US 2023/0208201 A1
(43) Pub. Date: Jun. 29, 2023

(54) Wireless Charging of Devices

(71) Applicant: SINTEF TTO AS, Trondheim (NO)

(72) Inventors: Tobias Dahl, Trondheim (NO); Jostein Thorstensen, Trondheim (NO)

(21) Appl. No.: 17/926,555

(22) PCT Filed: May 20, 2021
(86) PCT No.: PCT/GB2021/051229

§ 371 Date: Nov. 18, 2022

(30) Foreign Application Priority Data
May 21, 2020 (GB) 2007601.4

(51) Int. Cl. H02J 50/30; H02J 50/80; H02J 50/90; H02J 7/35; H02J 13/00

(52) U.S. Cl. CPC H02J 50/30; H02J 50/80; H02J 50/90; H02J 7/35; H02J 13/00022

(57) ABSTRACT

A system for wirelessly charging at least one device is disclosed. The device has a photovoltaic cell for converting incident light into electrical energy. The system also has a supply unit arranged to transmit a laser beam to the photovoltaic cell of the device. The supply unit is arranged to transmit the laser beam with a first divergence angle during a first mode and a second, narrower, divergence angle during a second mode following the first mode. The supply unit is arranged to change from the first mode to the second mode based on information relating to the location of the device.

### BACKGROUND

With the continued proliferation of electronic devices, particularly those where it is not convenient or possible to provide a permanent wired connection to a mains power supply, and growing expectations for the functionality and battery life that these provide, there remains an important focus on how such devices are charged.

There have been a number of developments in charging technology in recent years, most notably the introduction of magnetic induction charging to avoid the need for a physical coupling between the charger and the device being charged. Whilst this technology may be well suited to personal portable devices such as smart phones, smart watches, tablets etc., the need for a close physical proximity between the device and the charging surface does not make this technology suitable in all circumstances.

There have also been proposals to use lasers to provide power to charge devices by using the laser to illuminate a suitable photocell on the device. This has the advantage of removing the need for the device to be held close to a charging surface. However it suffers from some significant drawbacks. One of these is the requirement to have in place a suitable feedback system to ensure alignment between the laser and the photocell. Another is that a line of sight is required between the charging unit and the device which may cause difficulties in some environments or mean that additional charging units are needed.

Most significantly however, is that the above-mentioned laser charging methods are only capable of providing low charging currents. On one hand, although there are steady improvements being made, the efficiency of photovoltaic cells is still in general a long way below the theoretical maximum. On the other hand, there are stringent safety restrictions on the power levels for lasers that can be used in ordinary public, workplace or domestic settings.

For these and other reasons, the aforementioned remote laser charging has yet to be widely adopted.

The present invention seeks to address at least some of the above and when viewed from a first aspect provides a system for wirelessly charging at least one device, said device comprising a photovoltaic cell for converting incident light into electrical energy, the system further comprising a supply unit arranged to transmit a laser beam to the photovoltaic cell of the device, wherein the supply unit is arranged to transmit said laser beam with a first divergence angle during a first mode and a second, narrower, divergence angle during a second mode following the first mode, wherein the supply unit is arranged to change from the first mode to the second mode based on information relating to the location of the device.

Thus it will be seen by those skilled in the art that in accordance with the invention the divergence of a charging laser beam can be changed based on information regarding the location of a device to be charged (DTC). This advantageously allows a wider laser beam to be employed when the system has little or no information regarding the location of the DTC—so that a larger area can be swept or scanned to try to hit the device, but knowledge of the device's location can allow a smaller beam to be used (which can then deliver more power density) when the location of the DTC has been narrowed down.

### SUMMARY

In a set of embodiments the information relating to the location of the device is obtained by scanning the laser beam over a scan volume during the first mode and the supply unit receiving a notification prompting it to change to the second mode when the laser beam impinges on the photovoltaic (PV) cell. As will be appreciated, such an arrangement allows the system to determine at least an approximate location of the DTC by correlating receipt of the notification (or a time stamp in the notification) with a control algorithm for the laser beam scan which can establish a direction in which the laser beam was pointing when it impinged on the PV cell. Depending on the precision of the location information, the narrower beam of the second mode may just be used immediately to charge the DTC. However in a set of embodiments during the second mode the supply unit scans the beam over a second, smaller scan volume based on said location information. This may allow more accurate location determination—e.g. by scanning the smaller beam more slowly. The beam may then be left pointing at the PV cell to commence charging. Equally one or more further iterations of beam reduction and scanning may be envisaged.

The Applicant has recognised that even with the approach described herein, it is possible that the laser beam may be largely incident upon the PV cell but slightly misaligned such that not all of the available laser light energy is being used to power the device. In a set of embodiments, the system conducts a power delivery optimisation phase comprising a feedback loop wherein the beam is moved in response to a power value reported by the DTC to the supply unit. This could be used to improve the alignment of the illuminated area of the laser beam upon the PV cell. The power value reported to the supply unit is dependent on the power delivered to the DTC by the laser beam. In order to refine the alignment of the laser beam and PV cell, the laser beam may undergo small movements in position. The movement of the laser beam may be maintained if the power value is reported to rise and changed or reversed if the power value is reported to decrease. For example, if the DTC is situated on the x-y plane, orthogonal adjustments may be made based on the reported power values, first in the ±x direction and then the ±y direction, repeating iteratively. In a set of such embodiments, the power delivery optimisation phase may be halted when a suitable power value is reported by the DTC.

The optimisation of power delivery as described above may be performed only once by the system (e.g. at the beginning of charging). Equally, the optimisation of power delivery may be performed periodically and/or if a diminution in power is reported by the DTC.

In a set of embodiments the notification comprises a retro-reflection of the laser beam back to the supply unit. In other words compatible devices to be charged would need to comprise a retro-reflector arranged to reflect the laser beam back towards the supply unit when it impinges on the respective PV cell. Such an arrangement may be beneficial in that it does not require establishment of any other communication channel and can be entirely passive on the part of the DTC. This could be important for example if the DTC were completely discharged and thus had insufficient power to be able to communicate actively.

In another set of embodiments the notification comprises a signal sent over an independent communication channel when the DTC detects that the laser beam has impinged on its PV cell. Such a signal could be for any convenient type e.g. optical, ultrasound etc but in a set of embodiments comprises an RF signal. A dedicated format could be used but advantageously an established protocol could be used such as Bluetooth™, WiFi, Zigbee etc. In a set of such embodiments the laser beam in the first mode has sufficient power density to provide enough power to a device to be charged to be able to transmit the notification signal.

In accordance with the embodiments set out above, a scan zone is determined during the first mode in which the laser beam is scanned on order to locate the DTC. The ability in accordance with the invention to reduce the beam width once some location information is received may mean that it is practical for the scan zone to cover an entire region in which the DTC can validly be placed for charging—e.g. a room—with a suitably wide beam.

In a set of embodiments however the supply unit makes an initial determination (without scanning) of a portion of the entire region in which the device is located and sets the scan zone to be said portion for the first mode. In other words only a portion of said entire region is scanned. In a set of embodiments the initial determination is based on a signal transmitted by the device—which could be for example an optical, ultrasound or radio frequency signal. Such a signal could be in the form of a dedicated beacon or could be a signal transmitted for other purposes—e.g. as part of a WiFi, Bluetooth™ or LTE connection. The supply unit may employ any suitable technique or combination thereof for making the initial determination, e.g. beamforming, time of flight measurement, time difference of arrival, signal strength measuring etc.

In a set of embodiments (which need not be mutually exclusive with the foregoing) the initial determination is based on a signal reflected by the device to be charged. This might typically come from the supply unit but that is not essential. The signal could be RF. In other embodiments the signal is optical—e.g. the supply unit could comprise a camera, although this need not be high resolution—it could for example be more of an optical sensor which cannot form detailed images as such (to allay potential privacy concerns). In other embodiments the signal is acoustic—either audible or ultrasonic. In such embodiments simple echo-location could be used but equally the device could be provided with an acoustic resonator.

Whilst reference is made in the above to the location of the device, it should be understood that it is not in general necessary in accordance with the invention for the device to be static. Indeed the Applicant has appreciated that the principles of the invention may have significant advantage in allowing the charging of moving devices. This can be accommodated in general by determining that the alignment of the laser beam with the PV cell of the DTC has deteriorated and entering a subsequent scanning mode. Depending on the speed of movement relative to the speed of scanning and other factors affecting the time take to re-establish a ‘lock’, the divergence angle of the laser beam while it is charging could still be used. Alternatively the divergence angle could be increased again—either to an intermediate value or back to the divergence angle of the first mode. This would effectively ‘re-start’ the scanning process. Accordingly in a set of embodiments the system is arranged to return subsequently to the first mode and then to the second mode based on information relating to a revised location of the device.

In a set of embodiments where the DTC is in motion, the supply unit may use information relating to the movement of the DTC between incidence events, i.e. moments when the laser beam is determined to have been incident upon the PV cell of the device, to estimate the movement path of the DTC. The supply unit may use this information to decide how to move the charging laser e.g., to continue charging the moving DTC.

Where, in accordance with the set of embodiments set out above, the supply unit is arranged to make an initial determination of a portion of the entire region in which the device is located and to set the scan zone to be said portion for the first mode, this could also be carried out when the device has moved and the system returns to the first mode. Preferably however this is not repeated since the previous (known) location of the DTC can be used to determine the scan zone (e.g. the scan zone may be centred on the previous location and have a size which equates to the maximum distance a device is likely to be moved in a predetermined time taking into account physical constraints such as the speed of human movement).

Typically the supply unit will be fixed—e.g. to a ceiling of a room where it is relatively unobtrusive and would normally have the best line of sight view of devices in the room. However, it could equally be fixed on a wall or provided on a portable device which would provide the advantage that it could be moved to wherever required potentially on a temporary basis. It is even envisaged that the supply unit could be moved during use—recognising that this is in many senses equivalent to the devices moving whilst the supply unit is static.

In a set of embodiments, the supply unit comprises at least one steerable reflector, e.g. a micro-mirror, for directing the laser beam. In a set of such embodiments, the supply unit comprises a plurality of steerable micro-mirrors. This could, advantageously have overlapping fields of view which would allow a wider range of coverage than the operating range of an individual steerable micro-mirror was able to provide.

Although the foregoing description has only mentioned single devices to be charged, it will of course be appreciated that the system may be able to charge multiple devices. This could be done by using a time-division scheme whereby a single laser is moved between multiple devices (and potentially be in different modes with their differing divergence angles in respect of each device) in a cyclic pattern. Equally, a single laser source could be split to provide multiple laser beams (i.e. spatial division could be used) or multiple laser sources could be provided. Of course any combination of these could also be used.

### BRIEF DESCRIPTION OF THE DRAWINGS

Certain embodiments of the invention will now be described, by way of example only, with reference to the accompanying drawings in which;

FIG. 1a is an illustration of a wireless charging system in accordance with the invention;

FIG. 1b is a schematic illustration of a scan zone and laser beam for the system of FIG. 1a;

FIG. 2a is a schematic diagram of certain parts of the system of FIG. 1;

FIG. 2b is a detailed view of a micro-mirror which can be used in accordance with the invention;

FIG. 3 is a schematic diagram showing how the width of the laser beam is changed;

FIG. 4 is a schematic illustration of radio communication between a device and the central hub;

FIG. 5 is a flow chart describing the process for locating a device in accordance with an embodiment of the invention;

FIG. 6 illustrates scanning for a device with narrow and wide beams;

FIG. 7 illustrates part of the process set out in FIG. 6;

FIG. 8 is a flow chart describing the process for locating a moving device in accordance with another embodiment of the invention;

FIG. 9 illustrates part of the process set out in FIG. 8;

FIG. 10 illustrates a problem which may be encountered when a device is moving;

FIG. 11a is a schematic illustration of optical feedback in accordance with a further embodiment of the invention;

FIG. 11b is a schematic illustration of a variant of FIG. 11 a comprising a partially transparent mirror;

FIG. 12 is a schematic illustration of the retro-reflector of FIGS. 11a-b;

FIG. 13 is a schematic illustration of acoustic feedback shown as a variant on the embodiment depicted in FIGS. 11a-b;

FIG. 14 is a schematic illustration of feedback using a low res camera in accordance with a yet further embodiment of the invention;

FIGS. 15 and 16 illustrate schematically the provision of multiple laser beams with overlapping ranges;

FIG. 17 illustrates schematically multiple laser beams charging a single device; and

FIG. 18 illustrates schematically a moving hub unit charging a device.

### DETAILED DESCRIPTION

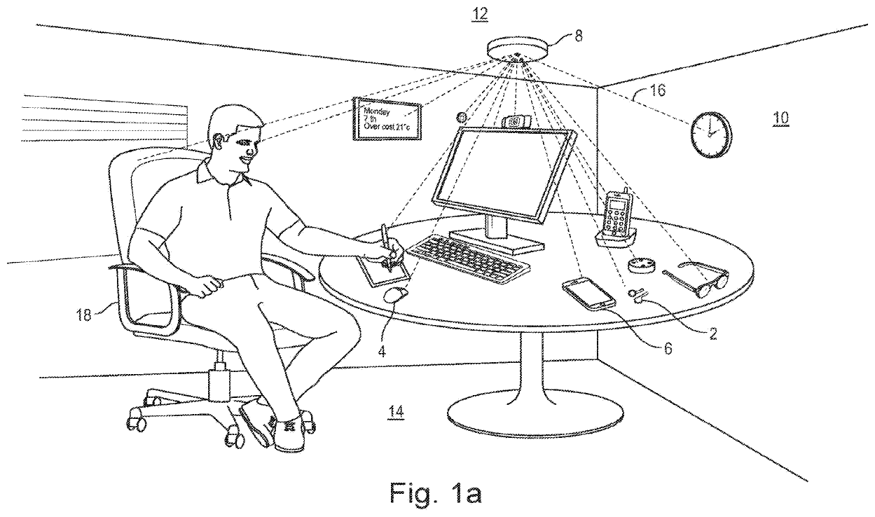

FIG. 1a shows a system for wirelessly charging a plurality of different electronic devices in a room e.g. wireless earphones 2, a wireless mouse 4, a mobile phone 6 etc. A supply unit in the form of a central hub 8 is mounted to the ceiling of the room. When mounted to a surface in this way, the hub 8 can be powered by the mains electrical supply.

The hub 8 has the capability to wirelessly charge devices anywhere within a charging zone. The charging zone in FIG. 1a is defined by the boundaries of the room i.e. the walls 10, ceiling 12, and floor 14. The hub unit 8 charges the devices 2, 4, 6 by means of a laser charging beam 16 represented by a dotted line. The devices-to-be-charged 2, 4, 6 all comprise a suitable photovoltaic device to convert power from the beam 16 into electrical power for charging an on-board battery or otherwise being stored (e.g. in a super capacitor). The beam 16 could also be used directly to power some functioning of the respective device. It is important for the wavelength and power of the beam to be chosen with consideration of eye-safety regulations. Laser safety standards require the observance of exposure limits to prevent eye injuries. This limit is known as the ‘maximum permissible exposure’ (MPE) which is a calculated value dependent on inter alia the properties of the laser source that is used. The international standard for laser safety is IEC 60825-1:2014 and equivalently for the US is (ANSI) Z136, and both standards include methods for calculating the MPE. For a charging laser, the beam must be safe, but must also transfer enough energy to charge the device in a reasonable time. Up to 0.5 W certain near-infrared wavelength lasers are considered to be safe. Alternatively, the source could generate a higher power charging laser (e.g. P>0.5 W) with a safety interlock switch mechanism which turns off the power when the line of sight to the device is broken, but this is significantly more complex.

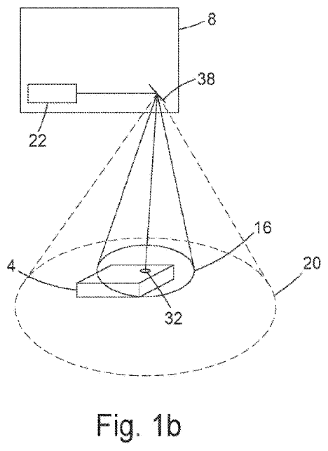

FIG. 2a shows schematically some more details of the hub 8 charging a device e.g. 4. The hub 8 comprises a laser source 22, a processor 24, beam-shaping optics 36, and a steerable reflector herein referred to as the mirror 38 for directing the charging beam 16 toward the device-to-be-charged 4. The device-to-be-charged 4 comprises a photovoltaic device 32, e.g. the C30665GH available from Excelitas. Here, the charging laser beam 16, which is emitted from the hub 8, could be generated by an off-the-shelf laser diode 22, e.g. the TO9-175 available from SemiNex. As can be seen in FIG. 2a, after passing through beam-shaping optics 36, the beam is incident on a steerable mirror 38. The mirror 38 then deflects the beam 16 so that it is output from the hub 8 and impinges on the photovoltaic cell 32 of the device-to-be-charged (DTC) 4.

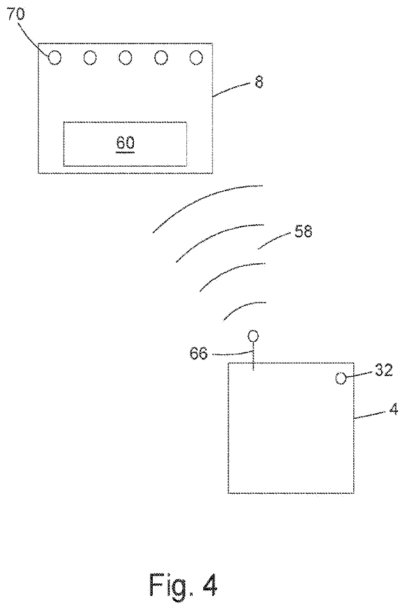

The processor 24 within the hub 8 has the capability to process steering instructions to control the tilting angle of the mirror 38, based on information obtained during localisation of the device-to-be-charged 4. The processor 24 also connects to a wireless communication module to communicate with the device-to-be-charged 4 over a radio communication channel—e.g. Bluetooth™. The localisation process will be described in detail below with respect to the corresponding flow-charts in FIGS. 5 & 8.

One example of a micro-mirror that can be used is shown in FIG. 2b and described in more detail in U.S. Pat. No. 9,250,418. FIG. 2b illustrates a MEMS micro-mirror 38 based on a ring shaped membrane 304 providing a coupling means between a rigid optical element 306 e.g. of silicon and a frame 308. An actuator is provided which is split around its circumference into four arcuate sections 310a, 310b, 310c, 310d. Corresponding inner actuator parts (not shown) are also provided. Piezo-resistors 312 are provided for position measuring. These piezo-resistors 312 are positioned in the gaps between the actuator sections.

The actuator sections 310a, 310b, 310c, 310d are positioned on the membrane 304 defining a coupling area between the frame 308 and the rigid element 306. The actuator sections 310a, 310b, 310c, 310d deflect the rigid element disc 306. The optical element 306 is rigid so as to maintain essentially the same shape when moved by the actuator elements 310a, 310b, 310c, 310d. The actuator elements 310a, 310b, 310c, 310d are preferably positioned close to either the frame 308 or the rigid element 306, so that when the piezoelectric material contracts, the part of the actuator positioned on the membrane is bent upward thus pulling the membrane in that direction.

A number of laser and micro-mirror parings may be provided to give full 360° coverage around the room. The laser 16 and mirror 38 may be controlled by the processor 24 or a separate controller unit might be provided.

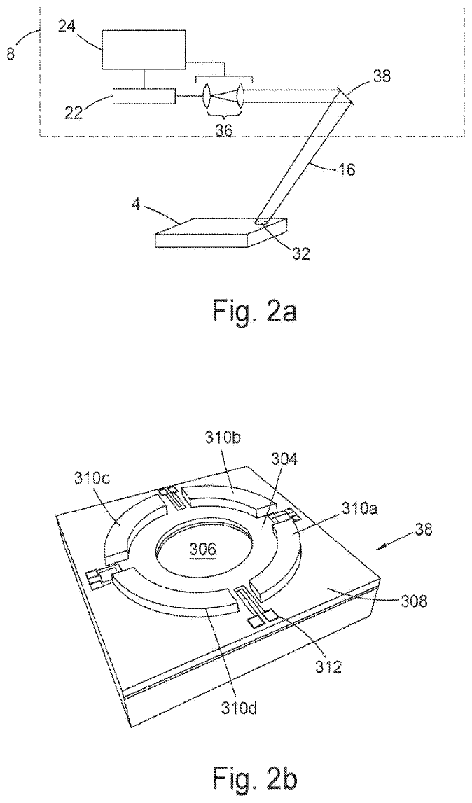

Turning to FIG. 3, there can be seen a more detailed representation of the beam-shaping apparatus 36 and the moveable mirror 38 inside the hub 8. The beam-shaping apparatus 36 varies the diameter of the beam and the mirror 38 directs the beam from the hub 8 to the device-to-be-charged 4.

The beam-shaping optics in FIG. 3, are represented as a simple lens pair 36 where the distance between the lenses determines whether the beam narrows or expands. The lens pair in this example comprises two converging lenses 40, 42 separated by a distance defined by the sum of their focal lengths, forming a simple Keplerian beam expander. In this geometry, reducing the relative distance of the two lenses results in a diverging beam with the focus behind the beam expander, and conversely, increasing the relative distance results a converging beam with the focus in front of the beam expander. The minimum beam diameter is produced when the beam expander is approximately balanced, and the focus is close to the DTC. FIG. 3 shows an example of both a narrower beam 44 which has a relatively small divergence angle and a wider beam 46 which has a relatively large divergence angle.

Galilean beam expanders are a more compact alternative, where the lens pair comprises both a positive lens and a negative lens which have a separation much shorter than in Keplerian geometry. Beam expanders are available off the shelf, therefore, a Keplerian or Galilean beam expander suitable for the wavelength of the charging laser can be used, e.g. the GBE20-C available from Thorlabs.

The steerable mirror 38, which in this case has a MEMs architecture, directs the beam in response to instructions from the control logic in the processor 24 of the hub 20. The mirror 38 may be able to direct the beam over a sufficiently wide range of angles that devices can be charged wherever they are in the charging zone. Alternatively, as will be described later, additional steps may be taken to increase coverage.

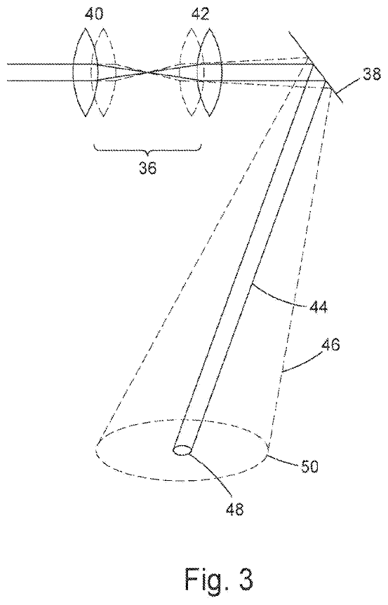

With reference to FIG. 4, in a first embodiment, the device-to-be-charged 4 comprises a Bluetooth™ transducer 66 and communicates information relating to its location to the hub 8 by transmitting a Bluetooth™ signal 58 to be received by a transducer 70 at the hub 8.

The hub 8 comprises a Bluetooth™ receiver array 70 and a module 60 which controls processing of Bluetooth™ communications (which may be part of the main processor 24). The receiver array 70 in FIG. 4 is a phased array of receiver elements 70, which gives the advantage of higher positional resolution when searching for the device 4, in comparison to when a single receiver element is used as will be explained below.

Operation of the system set out above will now be described with further reference to FIGS. 5 to 8.

Turning to FIG. 5 the operation starts at step 90 with identifying a ‘crude’ position of the device-to-be-charged 4. This is done by the hub 8 detecting the Rf signals 58 transmitted by the device 4 by virtue of it being enabled for Bluetooth™ communication. The device 4 can also be identified by the hub 8 through transmitting identity data over this RF channel. For the purpose of this part of the operation, it is not necessary that the device 4 is paired with the hub 8 (although that may be beneficial)—e.g. the hub 8 could simply listen to periodic advertising messages transmitted by the device 4 or the device could be configured to transmit more specific beacon signals.

After receiving the incident radio signal 58 at the receiver array 70, the hub 8 can process the signals from each receiver element, employing beamforming techniques, in order to determine an estimate of the direction of arrival of the signal 58. This may be sufficient to determine the crude location of the device 4 (i.e. narrowing it down to a conical zone defined by the accuracy of the result of the beamforming calculation). Alternatively additional information might be used such as the received signal strength (which gives an indication of distance between the device 4 and the hub 8) or previous location. The portion of the charging region (i.e. room) which the hub determines the device 4 to be in is defined as a scan zone. An example of a scan zone 20 in relation to the narrower scanning/charging laser beam 16 is schematically depicted in FIG. 1b. The hub determines at step 92 whether crude location of the device is successful and based on this either returns to trying to localise the device 4 or continues to commencing fine localisation at step 94.

Fine localisation is based on scanning the laser beam 16 across the scan zone until it hits the PV cell 32 on the device-to-be-charged 4. The device 4 detects the spike in voltage or current produced by the PV 32 cell when this happens and communicates with the hub 8 to confirm that the device 4 has been found, i.e. notifying the hub 8 when the device 4 has been hit by the charging beam 16. For this it would normally be necessary for the device 4 and hub 8 to be paired.

The capability of the mirror 38 to tilt, e.g. made possible by a servo motor, galvanometer, or MEMs architecture, facilitates the scanning motion necessary to search the scan zone for the device-to-be-charged 4.

The area illuminated by the laser beam when it is incident upon a surface is referred to as the illuminated area 48, 50 of the beam (see FIG. 3). This illuminated area does not have to be exactly defined, as technically, the skilled person would appreciate that a laser beam profile extends infinitely outwards becoming more diffuse over that distance. The term, illuminated area 48, 50, simply refers to the central area of the beam incident on a surface which delivers a useful amount of energy. The skilled person would understand that, owing to the many different ways that a beam diameter may be determined, the useful area may be determined using measurements such as the

$$\frac{1}{{e}^{2}}$$

diameter, or the 4σ diameter, or the diameter which encompasses a defined percentage of the incident intensity e.g. 99%. These measurements depend on the divergence angle of the laser beam and encompass an area where the majority of the laser power is delivered. It is also important to note that this illuminated area could be an elongated ellipse, and will not always be circular.

As will be seen in FIG. 3, the more focused beam 44 with a smaller divergence angle and smaller illuminated area 48 is more suitable for efficiently charging the device 4 as the energy density is greater, whereas the wider beam 46 with a greater divergence angle and hence illuminated area 50 is more suitable for covering a larger area of interest. As will be explained below this wider beam 46 allows the device-to-be-charged 4 to be found quickly during scanning, and can also be useful when the system is used for tracking a moving device.

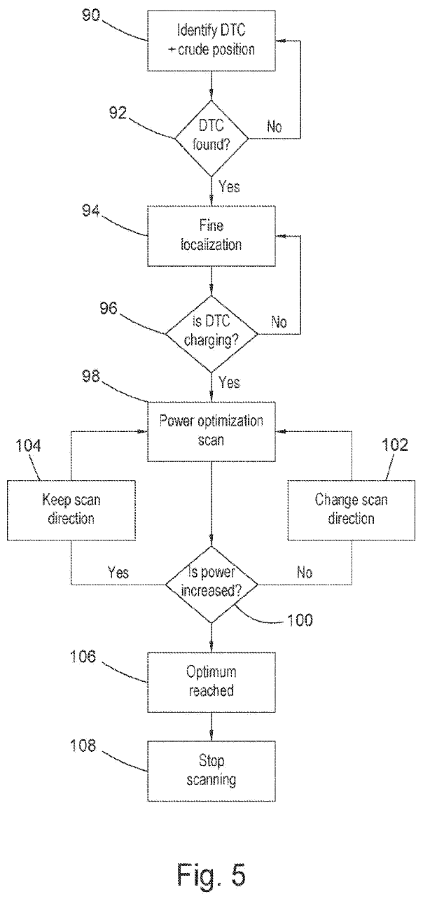

FIG. 6 is a schematic diagram illustrating why varying the divergence angle of the laser beam is beneficial. If scanning the scan zone to find the PV cell 32 on the device to be charged 4 were carried out using a beam with a narrow illumination area 48 matched to the size of the PV cell 32 were carried out, the first scanning path 126 shown by an arrow is tightly packed and it will therefore take a long time before it hits the PV cell 32. By contrast if a beam giving a larger illuminated area 50 is used the associated second scanning path 130 during the same time period, a larger area is covered and so the PV cell will be hit more quickly.

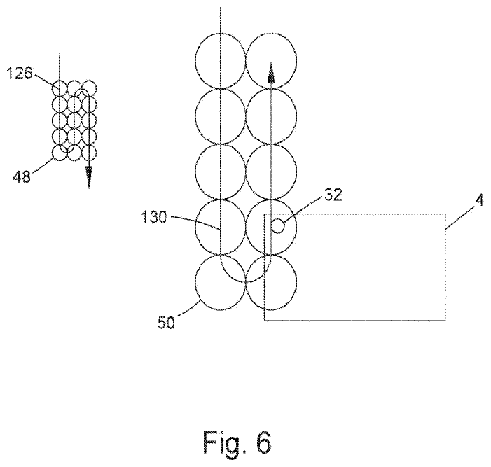

FIG. 7 schematically shows in more detail the fine localisation process using beam-shaping in combination with scanning. There can be seen the device-to-be-charged 4 with its photovoltaic cell 32. A scan zone 144 shown by a dashed outline has previously been defined. The illuminated area of the charging beam at discrete time-steps is represented by circles 148a, 148b, 148c, and the initial direction of scanning is shown by an arrow 150.

The hub begins by scanning the scan zone 144 along the scan path 150 with a beam having a relatively wide illuminated area 148a. FIG. 7 shows the wide beam scanning in two iterative steps 148b, 148c remaining in the first mode as the device is not detected. When the wide beam 148c impinges on the PV cell 32 of the device, the device 4 detects this and transmits a Bluetooth™ notification 58. Ideally even at its widest point the beam 148c has sufficient power density (and is scanned slowly enough) that the Bluetooth™ notification 58 can be transmitted from the device 4 even when it has a fully drained battery, as the beam can provide sufficient power to the device 4 to enable this.

Once the hub has been notified that the PV cell 32 of the device 4 has been hit, it enters a second mode whereby the divergence angle is reduced as described above with reference to FIG. 3 to give a smaller illuminated area 140. Moreover a reduced scan zone 146 is defined—represented by the dashed square in FIG. 7. This scan zone 146 is defined by the inherent uncertainty in the position of the beam when it hit the photovoltaic cell 142—e.g. due to tolerances in the steerable micro-mirror 38, uncertainties in timing of the notification 58 etc. Scanning using the narrower beam then continues until the PV cell 32 is hit once again. Since the scan zone 146 is significantly smaller, the scanning can take place more slowly even though the illuminated area 140 is significantly smaller. This may allow the scanning to be stopped as soon as the PV cell 32 is hit and the beam returned more precisely to where it was when that happened. In other embodiments a further iteration of reducing the beam size and scanning area could be carried out.

The fine-localisation step 94 of the flowchart in FIG. 5 is complete when the laser beam is stably incident upon the photovoltaic cell 32, i.e. when the device 4 is charging. The device 4 sends a further notification that it is charging through the Bluetooth™ communication channel as depicted in FIG. 4 which may include the power that is being received by the PV cell 32 as an indication of the degree of alignment of the laser beam.

If the system determines that the device-to-be-charged 4 is charging at step 96, then the next step of the process 98 can begin—optimising power delivery to the device. This step helps to minimise useful energy from the laser beam being lost by a slight misalignment of the beam.

In the power optimisation step 98, the beam is moved by small amounts around the area where the photovoltaic cell 42 was localised through minor adjustments of the steerable mirror 38. During this, the device 4 gives the hub 8 feedback 100, related to the instantaneous power being received by the device. These steps 98, 100, 102, 104 form an iterative process, such that the direction of movements is maintained 104 if power is increasing but changed 102 if power is decreasing. The result of the process 98, 100, 102, 104 is that the beam is directed to a point relative to the photovoltaic cell 32 which results in optimal or near optimal power delivery. Once this optimal position is reached 106 then the mirror 38 is fixed to that position and movement thereof is halted 108.

This optimisation process might be repeated periodically or if the device 4 notifies the hub 8 that the instantaneous power level it is receiving has dropped.

Although the process set out above mentioned only a single device 4, it could be repeated for a number of devices in the room. This could be moving the laser beam between devices (e.g. to provide time division access) once fine localisation for each device has been completed or it is also envisaged that the preceding steps could be carried out is specific timeslots allocated to respective devices.

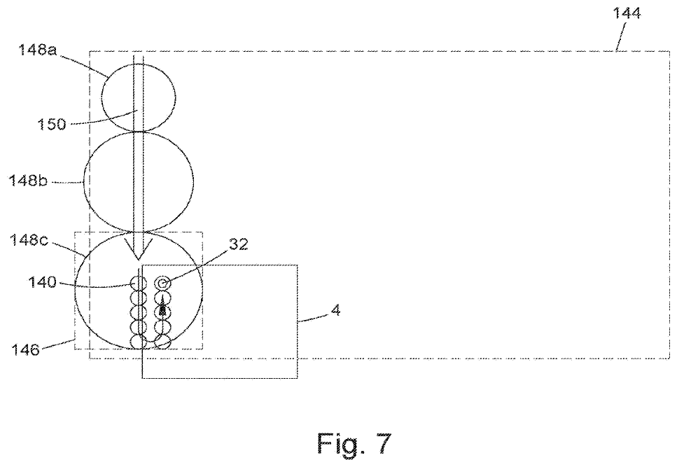

In the method described with reference FIG. 5, the device 4 is presumed to be static, e.g. because it is resting on a table. This means that once the location of the device 4 is determined, the mirror 38 can be fixed to a certain tilt angle and scanning halted. However, in another embodiment of the present invention, which will be described below with reference to FIGS. 8 to 10, the devices-to-be-charged can be moved or in motion during charging. An example of this might be a smart chair 18 (see FIG. 1a).

FIG. 8 is a flow chart describing how an embodiment localises a device-to-be-charged 18 using a combination of scanning and beam-shaping. The first step 110 involves scanning an area of interest (AOI) with a wide beam, i.e. one with a large divergence angle. In some cases the AOI is the entire room, in others it may be a smaller area where the device-to-be charged 18 is located—e.g. using Bluetooth™ signals as described with reference to the previous embodiment. This area is scanned 112, and if the device 18 has been hit by the beam, it communicates this to the hub 8, through transmitting a Bluetooth™ notification as before.

If at step 114 there is no new position estimate, e.g. because the scanning beam did not find the device 18, then the divergence angle of the beam is increased and a larger AOI is scanned at step 116. Conversely, if the hub 8 receives a notification that the device 18 has been hit, then the beam width, if it is larger than the minimum width 118, is reduced and the AOI is also reduced 120. The scanning step 112 and beam-shaping steps 114, 116, 118, 120 then continue iteratively until the beam is impinging upon the PV cell in the device 18 and the illuminated area of the beam is at a minimum.

At this stage, an optimal beam alignment is obtained by power-based fine-tuning 122, which is another iterative process similar to that outlined in the previous embodiment. In this step 122, the beam is moved around a small area around the photovoltaic cell of the device-to-be-charged 18 and the device 18 gives the hub 8 feedback based on measurements performed by the power meter. However if the device moves significantly thereafter, the optimisation will fail and the instantaneous power received will drop off typically to zero. When this is detected at step 124 the algorithm returns to step 116 to increase the divergence angle of the beam and AOI or scan zone and re-commence scanning for the device 18.

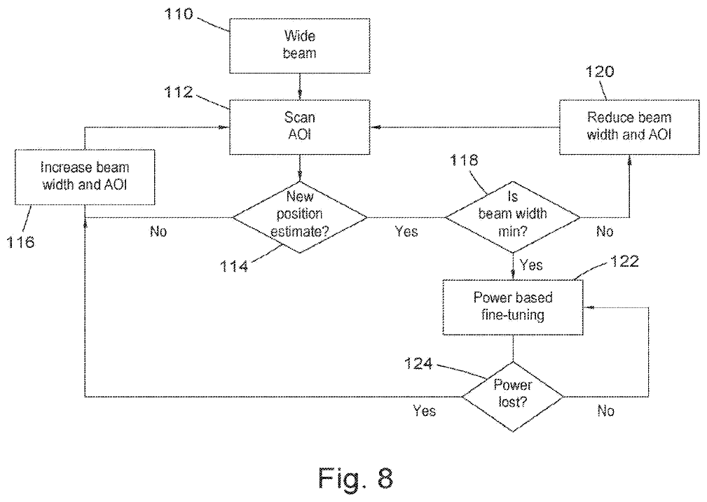

FIG. 9 is a schematic diagram illustrating the method outlined above showing how a device 18 (represented schematically) comprising a photovoltaic cell 152 can be localised with beam-shaping when in motion. The device 18 begins at a first position 158a on the left at a time t=0 and moves to a second position 158b on the right at a later time t=T. The arrow 154 shows the direction of movement of the device. The circles 156a-156c show the illuminated area becoming narrower as the photovoltaic cell 152 lies within the illuminated area 156a-156c of the beam (which is fed back to the hub via the Bluetooth™ channel). Then, when the device is moved toward the second position 158b, at 0<t<T the illuminated area 156d-156e expands and scans in approximately the direction 154 that the device has moved. The scan direction may be determined by monitoring the power delivered to the DTC during rapid small-scale movements of the beam, operating similarly to the stages illustrated in step 100 of FIG. 5 and step 122 of FIG. 8. This determination of scan direction is based on the reasonable assumption that the movement of the device is significantly slower than the movement of the beam and the speed of wireless communication. Although not shown in FIG. 9, when the beam 156f is at its largest, it again hits the PV cell 152 and then the illuminated area narrows again 156g-156i. The beam is also moved as this happens. This tracking capability could further be enhanced by incorporating positional modelling algorithms into the control logic in the processor 24 of the hub 8—to partially predict the path taken by the device—e.g. by comparing the positions at which the PV cell 152 was ‘hit’.

The foregoing description and Figures demonstrate that an advantage of embodiments of the present invention is that devices can be tracked by the beam and charged while in motion.

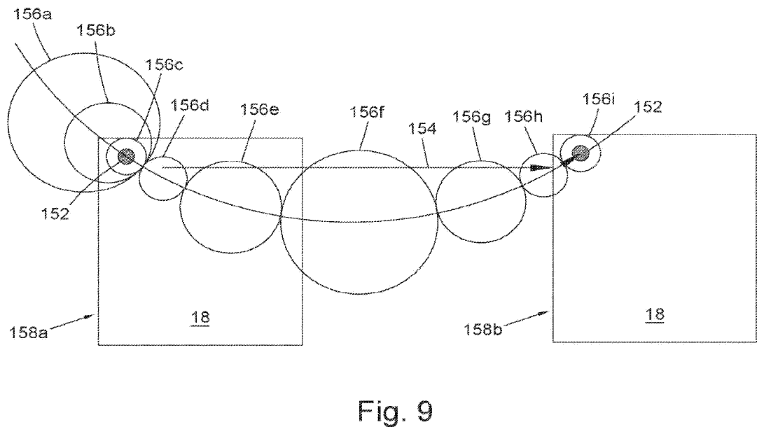

FIG. 10 illustrates the problem that would be likely to be encountered if scanning of the laser beam were used without the beam-shaping principle in accordance with the present invention. The schematic shows a device-to-be-charged 161 with PV cell 162. The device 161 is at a first position 168a on the right at a time t=0, and moves to a second position 168b on the left at a later time t=1. The arrow 164 shows the direction of movement.

A laser beam with a narrow divergence angle and therefore a small illuminated area 160 is scanned along a path indicated by the second arrow 166 in the same time period. It can be seen that in this exemplary system whilst the beam would eventually have reached the PV cell 162 if the device 161 had stayed in the initial position 168a, by the time it gets to that position the device has moved. Moreover the beam is unlikely to hit the PV cell 162 while the device 161 is in motion and even if it does, this would be temporary only and the alignment would soon be lost. It can be appreciated therefore that the beam-shaping principle outlined herein, which allows much faster scanning, is critical to being able to find, track and charge a device in motion.

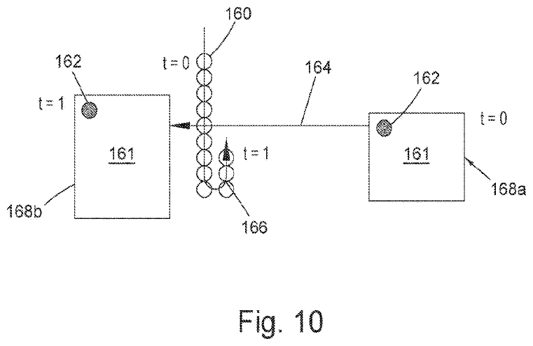

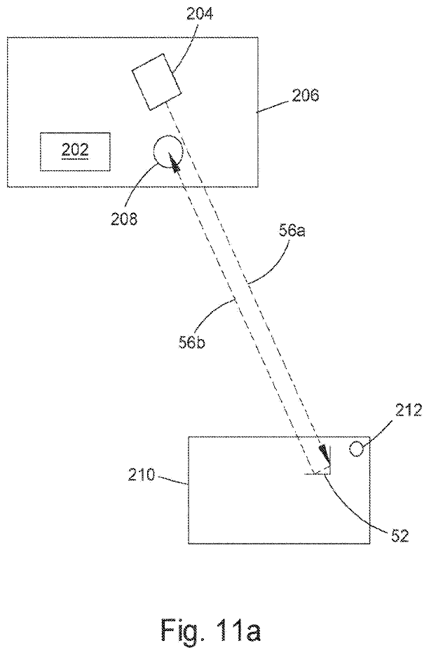

A further embodiment of the invention will now be described with reference to FIGS. 11a and 12. In this embodiment feedback from the device-to-be-charged 210 to the hub 206 that the charging laser beam 56a has become incident upon the device's PV cell 212 takes the form of a return beam 56b from a retroreflector 52. The hub 206 thus transmits the charging laser beam 56a from a laser source 204 and receives a reflected beam 56b at a suitable photodetector 208. The processor 202 uses this information to alter the divergence angle of the beam as described above in relation to previous embodiments. In FIG. 11b, a variant of FIG. 11a is shown, where a beam splitter is positioned between the photodetector 208 and retroreflector 52, demonstrating that the laser source 204 and photodetector 208 may be positioned further from each other within the hub 206.

As will be familiar to those in the art and illustrated in FIG. 12, a retroreflector 52 reflects a light bean incident on it back in the opposite direction. FIG. 12 shows an example of this in the form of a corner cube retroreflector 52. From this it will be appreciated that incident beams 54a 56a from two different directions are reflected back along respective paths 54b, 56b in the opposite direction. The corner cube retroreflector 52 is a common geometry, e.g. the PS974-B available from Thorlabs.

The incident signals 54a, 56a are each comprised of an optical beam. The optical beam in this example is the charging laser e.g. with a wavelength in the near-infrared part of the spectrum. However, this beam could be any other suitable wavelength, e.g. a beam which is separate to the charging beam with a wavelength in the visible part of the spectrum. It will be appreciated by the skilled person, that in this geometry, the incident beam 54a, 56a and reflected beam 54b, 56b are substantially parallel, for a range of incident angles. Retroreflectors reflect radiation back towards the source with little scattering. Therefore, when the charging beam is incident on the device-to-be-charged 4 during scanning i.e. when the retroreflector 52 has been illuminated, a return signal 54b, 56b can be received by the hub 206. Reflecting means such as the retroreflector 52 enable passive communication from the device 4 back toward the hub 206 without requiring the device-to-be-charged 210 to know the location of hub 206 or even to have any power. A passive communication device such as this offers a low-cost and simple way to receive information relating to the position of the device.

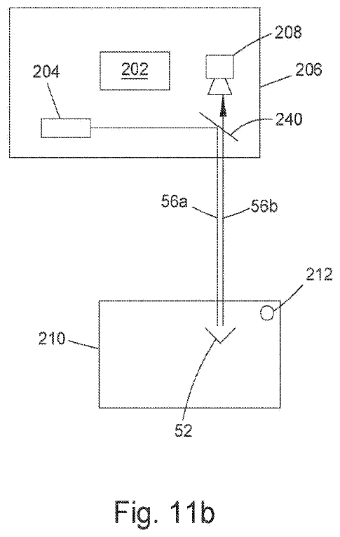

A further example of passive communication, acoustic feedback rather than optical, is depicted schematically in FIG. 13. Similarly to what is shown in FIGS. 11a-b, a signal 220a is reflected at the DTC 210 and returned to the source. The signal is transmitted from the hub 206 by an array of acoustic transducers, e.g. ultrasound transceivers. The signal 220a is incident upon an acoustic retroreflector 218 on the DTC 210, and returns back toward the array of transducers 216. The received signal 220b is communicated to the processor 214, where the location of the DTC 210 is determined. As this example shows an array of receivers, beamforming and time of flight measurement, or any other suitable method for obtaining the direction and distance of a signal, may be performed to obtain more positional information from the signal 220b.

Other operation of the wireless charging system involving the variants shown in FIGS. 11a-b, and 13 may be the same as in previous embodiments.

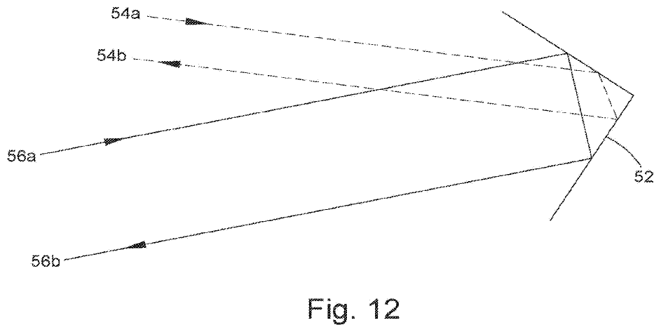

FIG. 14 shows a representation of another embodiment having a different method of determining the location of a device 78 and more particularly the PV cell thereof 72. In this embodiment the hub 74 comprises a relatively low resolution camera 88 and a processor 80. The device-to-be-charged 78 comprises a photovoltaic cell 72 and a visible marker 76 which has a known position relative to the PV cell 72. The line-of-sight from the camera 88 to the visible marker 76 is represented by a line 82.

In this embodiment, the hub 74 can locate the PV cell 72 of the device-to-be-charged 78 by using the camera 88 to detect the position of the visible marker 76, which is exemplified here by a two-dimensional binary code, e.g. an ArUco marker 76. The relative displacement, from the visible marker 76 to the photovoltaic device 72 is used by the processor 80 to direct the charging beam 84 towards the photovoltaic device 72. In this embodiment the camera 88 is chosen to have the lowest possible resolution, while retaining the ability to detect the visible markers 76, in order to allay possible privacy concerns of users of the wireless charging system.

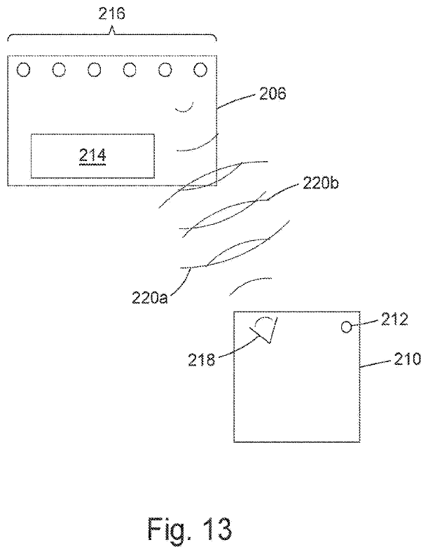

The hub may comprise various relative arrangements of the laser source(s) and moveable mirror(s). Some examples of how these components may be placed in the hub will now be described with reference to FIGS. 15, 16 and 17. The beamshaping optics 36 of the hub 8 have been omitted from the following drawings for the purpose of simplicity.

FIG. 15 shows highly schematically how multiple laser beams can be generated from a single laser source 170. This arrangement comprises a primary moveable mirror 174, and a plurality of secondary moveable mirrors 178a, 178b, 178c which direct a plurality beams to be output from the hub. In this example, the moveable mirrors are steerable MEMS mirrors.

The primary mirror 174 directs the initial beam 172 from the laser source 170 into three separate beams 176a, 176b, 176c by tilting the primary mirror 174 appropriately. The range of coverage of beams from the respective secondary mirrors on a surface 180a, 180b, 180c are partially overlapping. The secondary mirrors 178a, 178b, 178c increase the coverage within the charging zone compared to what could be achieved with the limited maximum movement of a single steerable mirror without requiring additional laser sources.

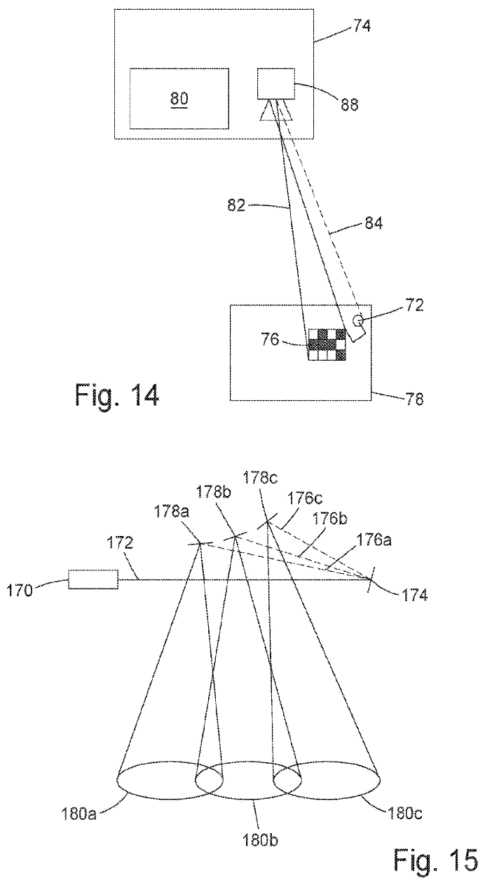

FIG. 16 shows an alternative approach whereby coverage extension is achieved through the use of multiple laser sources 188a, 188b, 188c which respectively generate a plurality of corresponding laser beams 182a, 182b, 182c which are each directed toward separate MEMS mirrors 184a, 184b, 184c. Each of the beams can be individually directed out of the hub and independently steered by tilting each mirror 184a, 184b, 184c to give overlapping coverage 186a, 186b, 186c. This provides the advantage of being able to deliver a greater average power across the total coverage and also may allow faster scanning as the areas 186a, 186b, 186c can be covered simultaneously.

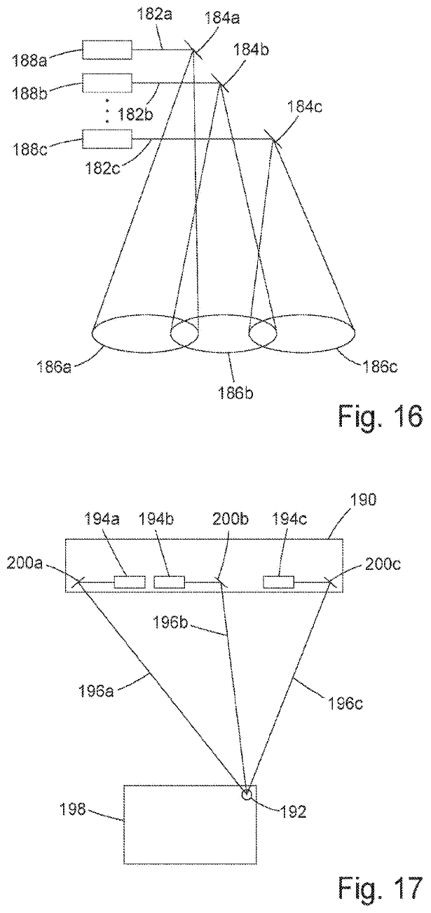

FIG. 17 schematically shows a wireless charging system comprising a plurality laser sources 194a, 194b, 194c and a plurality of moveable mirrors in the form of MEMS mirrors 200a, 200b, 200c with each laser source having a moveable mirror positioned to align with its output. This arrangement shows the output of the laser sources spaced at least 10 cm apart for safety purposes.

There can be seen a device-to-be-charged 198 comprising a photovoltaic cell 192. The device-to-be-charged 198 is shown to receive the three charging lasers 196a, 196b, 196c at a common point on the photovoltaic cell 192 of the device. This demonstrates the possibility of combining and overlapping laser beams, to increase power delivery to a single device 198 without the risk of an unsafe level of laser power being present elsewhere in the area.

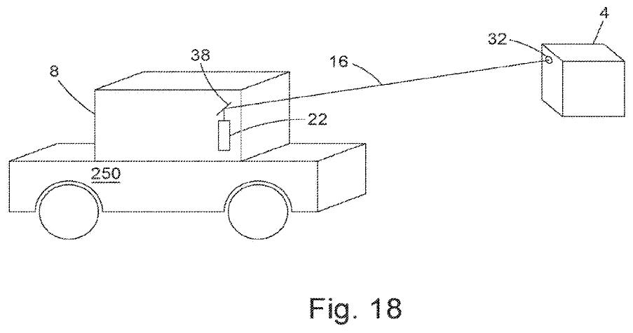

In the above, it has been demonstrated that the hub unit 8 of the wireless charging system can be stationary, e.g. positioned at the centre of the ceiling as shown in FIG. 1a. However, the hub unit 8 can equally be in motion, as shown in FIG. 18. FIG. 18 shows an example of a hub 8 in motion, in the form of a remote-controlled hub travelling throughout a large room—possibly a warehouse—charging DTCs, e.g. 4, whilst operating just above floor-level. The hub 8 is mounted to a wheeled remote-controlled carriage 250 and transmits a charging beam 16 toward the PV cell 32 of the DTC 4 with the effect of powering the device. The principles of operation set out above relating to moving devices to be charged will be applicable to this situation as there will be relative movement between the hub and the device(s) even if the device is stationary.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description.

1. A system for wirelessly charging at least one device, said device comprising a photovoltaic cell for converting incident light into electrical energy, the system further comprising a supply unit arranged to transmit a laser beam to the photovoltaic cell of the device, wherein the supply unit is arranged to transmit said laser beam with a first divergence angle during a first mode and a second, narrower, divergence angle during a second mode following the first mode, wherein the supply unit is arranged to change from the first mode to the second mode based on information relating to the location of the device.

2. The system of claim 1, arranged to obtain the information relating to the location of the device by scanning the laser beam over a scan volume during the first mode and the supply unit receiving a notification prompting the supply unit to change to the second mode when the laser beam impinges on the photovoltaic cell.

3. The system of claim 2, wherein the notification comprises a retro-reflection of the laser beam back to the supply unit.

4. The system of claim 2, wherein the notification comprises a signal sent over an independent communication channel.

5. The system of claim 4, wherein the notification comprises a radio frequency signal.

6. The system of claim 4, wherein the laser beam in the first mode has sufficient power density to provide enough power to the device to be able to transmit the notification signal.

7. The system of claim 2, wherein the supply unit is arranged during the second mode to scan the beam over a second, smaller scan volume based on said location information.

8. The system of claim 7, wherein the supply unit is arranged to carry out one or more further iterations of beam reduction and scanning.

9. The system of claim 1, arranged to conduct a power delivery optimisation phase comprising a feedback loop wherein the beam is moved in response to a power value reported by the device to the supply unit.

10. The system of claim 9, arranged to halt the power delivery optimisation phase when a suitable power value is reported by the device.

11. The system of claim 1, arranged to determine a scan zone during the first mode in which the laser beam is scanned on order to locate the device.

12. The system of claim 11, wherein the supply unit is arranged to make an initial determination of a portion of the entire region in which the device is located and to set the scan zone to be said portion for the first mode.

13. The system of claim 12, wherein the initial determination is based on a signal transmitted by the device.

14. The system of claim 12, wherein the initial determination is based on an optical or acoustic signal reflected by the device to be charged.

15. (canceled)

16. (canceled)

17. The system of claim 1, wherein the system is arranged to return subsequently to the first mode and then to the second mode based on information relating to a revised location of the device.

18. The system of claim 1, wherein the supply unit is arranged to use information relating to a movement of the device, between moments when the laser beam is determined to have been incident upon the photovoltaic cell of the device, to estimate a movement path of the device.

19. The system of claim 1, arranged to return to the first mode when the device has moved and to use a previous known location of the device to determine a scan zone.

20. The system as claimed in claim 19, wherein the scan zone is a portion of the entire region centred on a previous known location having a size which equates to a predetermined maximum distance the device may have moved in a predetermined time.

21. The system of claim 1, wherein the supply unit comprises at least one steerable reflector for directing the laser beam

22. The system of claim 1, wherein the supply unit comprises a plurality of steerable micro-mirrors.
